(19) United States
(12) Patent Application Publication
(10) Pub. No.: US 2021/0019717 A1
(43) Pub. Date: Jan. 21, 2021

(54) METHOD AND SYSTEM FOR MANAGEMENT OF DIGITAL MEDIA RIGHTS VIA BLOCKCHAIN

(71) Applicant: MASTERCARD INTERNATIONAL INCORPORATED, Purchase, NY (US)

(72) Inventors: Stephen Patrick FLINTER, Dublin (IE); Hao TANG, Singapore (SG); Justin PINKHAM, Ridgefield, CT (US); Karl INGRAM, Dublin (IE); Holly LYSAGHT, Athgarvan (IE)

(73) Assignee: Mastercard International Incorporated, Purchase, NY (US)

(21) Appl. No.: 16/512,948

(22) Filed: Jul. 16, 2019

(51) Int. Cl. G06Q 20/12; G06Q 20/36; H04L 9/06

(52) U.S. Cl. CPC G06Q 20/1235; G06Q 20/3672; H04L 9/0637; G06Q 20/3678

(57) ABSTRACT

A method for storing platform-agnostic digital media rights on a blockchain includes: receiving a transaction message related to a payment transaction, wherein the transaction message is formatted according to one or more standards and includes at least a plurality of data elements, the plurality of data elements including a first data element storing a primary account number and a second data element storing a product identifier; identifying a digital content identifier mapped to the product identifier; identifying a digital token mapped to the primary account number; generating a new blockchain data entry, wherein the blockchain data entry includes at least the digital token and the digital content identifier; and transmitting the new blockchain data entry to at least one node of a plurality of nodes comprising a blockchain network.

### FIELD

The present disclosure relates to the management of digital media rights via blockchain, specifically the storage of platform-agnostic media rights via blockchain for the purchase of viewing rights for digital media that is platform independent for viewing of the digital medial using any suitable platform.

### BACKGROUND

The rise of smart devices and vast availability of high speed internet have led to a world where many individuals take in their digital media content through on-demand streaming and online downloads as opposed to the use of physical media or traditional cable-type implementations. The world of streaming and digital media downloads has become so prevalent that companies now exist solely to provide on-demand, streamed video content to users, and many users have been foregoing traditional cable subscriptions entirely. Users tend to want content that is selected specifically by them, and delivered precisely when they want it, and through a device of their choosing.

At the same time, due to the nature of capitalism and competition, as soon as one platform began to provide on-demand streaming services to consumers, competitors rose offering competing platforms. In the last several years, the existence of multiple streaming services fighting over rights to digital media has led to a complicated network of digital media rights in terms of what services have what rights to what portions of content for various media distributors. Such a complicated web of rights and platforms leads to confusion and frustration for consumers that want a more simplified, convenient process for consuming content.

One of the more complicated aspects for consumers is the separation from one digital media viewing platform to another. A consumer may purchase a movie for download from one platform and have it stored on their tablet for viewing on the go. At the same time, that consumer may want to watch the movie on their television. The user may have multiple streaming services accessible through their television, one or more of which may have that movie available to stream. However, these streaming services each require the consumer to pay a subscription fee to access their content, or may require the consumer to purchase the movie through their own platform. Thus, the consumer is faced with the decision to either purchase the movie a second time, be restricted to watching the movie on devices where they can download it through their initial purchasing platform, or discover a way to watch the video on the television streamed through their tablet.

For many consumers, the most convenient solution would be to be able to purchase rights to view digital media once for viewing of the digital media on any available platform. However, such a solution does not currently exist, quite possibly because centralizing controls and coordinating communications between the different platforms would be technological nightmare. Furthermore, many rights owners and viewing platforms are resistant to such solutions as any centralized storage of rights could be subject to single mode failures (where one fault shuts off an entire system and its service, unfair influence, leading to repeats of the current system. Thus, there is a need for a system where platform-agnostic digital media rights can be stored that is decentralized and free from potential unfair influence by viewing platforms that does not require brute force integration or the like across multiple platforms potentially having multiple communication protocols and software requirements.

### SUMMARY

The present disclosure provides a description of systems and methods for storing platform-agnostic digital media rights on a blockchain. A digital rights owner may make an agreement with a merchant (or operate directly as the merchant) to sell rights for digital media owned by the entity. For instance, the digital rights owner may provide a merchant with permission to sell digital media rights in a physical or electronic storefront. When a consumer purchases the digital media rights, a transaction processor may identify the transaction is for the purchase of such rights, and may initiate the storage of a token for the user along with an identifier for the digital media content on a blockchain. The token and content identifier are stored on a blockchain, which is publicly viewable by any viewing platform. The consumer can then authenticate themselves (using the token) with a viewing platform, where the viewing platform can identify all content to which the consumer has purchased digital media rights in the blockchain. The result is that the consumer can view purchased content on any participating platform, and the digital rights owner maintains the ability to freely sell digital media rights through any method they prefer, without having to worry about exclusivity among platforms. Thus, consumers and digital rights owners are provided with significantly more freedom and flexibility in selling and consuming digital content.

A method for storing platform-agnostic digital media rights on a blockchain includes: receiving, by a receiver of a processing server, a transaction message related to a payment transaction, wherein the transaction message is formatted according to one or more standards and includes at least a plurality of data elements, the plurality of data elements including a first data element storing a primary account number and a second data element storing a product identifier; identifying, by a processing device of the processing server, a digital content identifier mapped to the product identifier; identifying, by the processing device of the processing server, a digital token mapped to the primary account number; generating, by the processing device of the processing server, a new blockchain data entry, wherein the blockchain data entry includes at least the digital token and the digital content identifier; and transmitting, by a transmitter of the processing server, the new blockchain data entry to at least one node of a plurality of nodes comprising a blockchain network.

A system for storing platform-agnostic digital media rights on a blockchain includes: a receiver of a processing server configured to receive a transaction message related to a payment transaction, wherein the transaction message is formatted according to one or more standards and includes at least a plurality of data elements, the plurality of data elements including a first data element storing a primary account number and a second data element storing a product identifier; a processing device of the processing server configured to identify a digital content identifier mapped to the product identifier, identify a digital token mapped to the primary account number, and generate a new blockchain data entry, wherein the blockchain data entry includes at least the digital token and the digital content identifier; and a transmitter of the processing server configured to electronically transmit the new blockchain data entry to at least one node of a plurality of nodes comprising a blockchain network.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for storing platform-agnostic digital media rights in accordance with exemplary embodiments.

FIG. 2 is a block diagram illustrating the processing server of the system of FIG. 1 for facilitating the storage of platform-agnostic digital media rights in a blockchain in accordance with exemplary embodiments.

FIG. 3 is a flow diagram illustrating a process for creating a new blockchain data entry for the purchase of digital media rights in the system of FIG. 1 in accordance with exemplary embodiments.

FIG. 4 is a flow diagram illustrating a process for the identification of owned digital media content through rights stored in a blockchain in the system of FIG. 1 in accordance with exemplary embodiments.

FIG. 5 is a flow chart illustrating an exemplary method for storing platform-agnostic digital media rights on a blockchain in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by Mastercard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

System for Storage of Digital Media Rights on a Blockchain

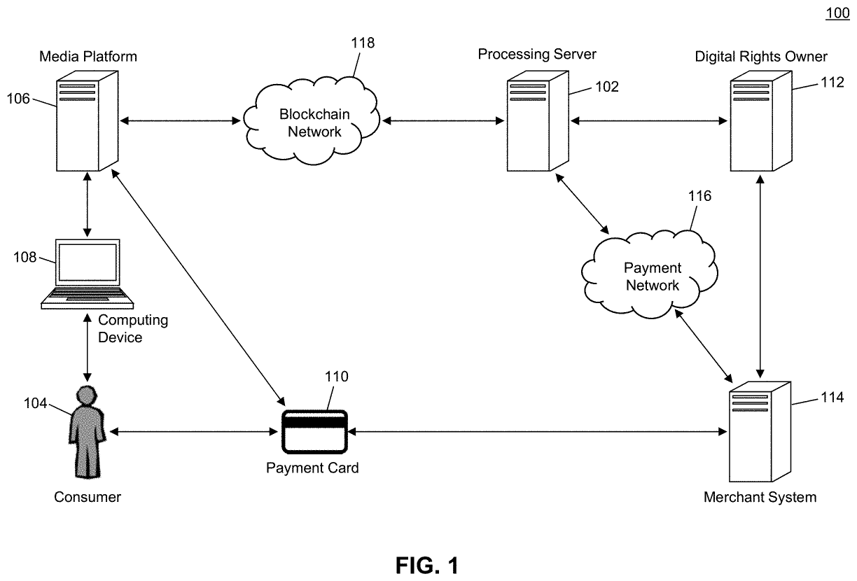

FIG. 1 illustrates a system 100 for the storage of digital media rights that are platform-agnostic on a blockchain to facilitate ownership of rights to digital media content that are independent of potential viewing platforms.

The system 100 may include a processing server 102. The processing server 102, discussed in more detail below, may be configured to facilitate the storage of digital media rights for digital media content that may be viewed by consumer 104. In the system 100, a consumer 104 may register with a media platform 106 for viewing of digital media content on a computing device 108. The computing device 108 may be any type of device suitable for displaying digital media content delivered by a media platform 106, such as a desktop computer, notebook computer, laptop computer, tablet computer, cellular phone, smart phone, smart watch, smart television, wearable computing device, etc. The media platform 106 may be an entity that provides a platform accessible by a computing device 108 for the viewing of digital media content delivered thereto through the platform. Media platforms 106 may be, for instance, applications provided by Netflix®, Hulu®, Amazon®, Google®, Apple®, etc.

Traditionally, the consumer 104 may purchase a subscription to the media platform 106 for the delivery of digital media content to the computing device 108, or may purchase individual pieces of digital media content from the media platform 106 for viewing on the computing device 108. In the system 100, the consumer 104 may be able to purchase the rights to digital media content from a digital rights owner 112 (e.g., directly, or indirectly as described below), where the corresponding digital media content may be viewable using any media platform 106 that has such digital media content available.

In the system 100, a digital rights owner 112 may establish an agreement with a merchant system 114 for the sale of digital media rights owned by the digital rights owner 112. The digital rights owner 112 may be, for instance, a content producer, content distributor, or other entity that has rights regarding sale and/or distribution of digital media content. For example, the digital rights owner 112 may be a movie studio that has distribution rights to its movies and any movies acquired from other studios. The agreement may provide the merchant system 114 permission to sell the digital media rights for one or more pieces of digital media content, either directly (e.g., where the consumer 104 explicitly purchases the digital media rights) or indirectly (e.g., where the digital media rights are provided as a gift or add-on to another purchase, for loyalty points, etc.). As part of the agreement, the digital rights owner 112 and/or merchant system 114 may establish a product identifier. The product identifier may be a unique value that is associated with the purchase that must be made by the consumer 104 for the acquiring of the digital media rights. For instance, the product identifier may be directly associated with the digital media rights, or may be associated with the accompanying product available for purchase for which the digital media rights are given. The product identifier may be any suitable type of value that is uniquely associated with digital media rights for a piece of digital media content. For example, the product identifier may be a universal product code, stock-keeping unit, registration number, serial number, or other unique value.

As the agreement is established, data regarding the agreement may be provided to the processing server 102, such as by the digital rights owner 112 and/or merchant system 114. The data may include at least the product identifier and a content identifier associated with the digital media content for which the digital media rights are acquired through the agreed-upon purchase. The content identifier may be a value that is unique to one or more pieces of digital media content that is used for the identification thereof, such as a unique alphanumeric or integer value. The processing server 102 may receive the data and may store the data as a content pair in a content database stored therein (e.g., or otherwise accessible thereby in an external storage, such as through a cloud-based storage solution), as discussed in more detail below.

Following establishment of the agreement of data values and storage of the content pair, the merchant system 114 may make the digital media rights (e.g., or accompanying product) available for purchase by the consumer 104. The consumer 104 may initiate a payment transaction with the merchant system 114 for purchase of the digital media rights and, as part of the initiation of the payment transaction, provide a payment card 110 or other payment instrument thereto. The payment card 110 may be encoded with or otherwise provide payment credentials to the merchant system 114 that are associated with a transaction account used to fund the payment transaction. The merchant system 114 may initiate processing of the payment transaction by submitting (e.g., directly or indirectly through one or more intermediate entities, such as an acquiring institution or gateway processor) transaction data for the payment transaction to a payment network 116 via payment rails associated therewith. The transaction data may include at least the payment credentials, a transaction amount, and the product identifier associated with the product (e.g., digital media rights or accompanying product) being purchased.

The payment network 116 may receive the transaction data and may process the payment transaction using traditional methods and systems. If the payment transaction is approved and processed accordingly, the payment network 116 may forward a transaction message for the payment transaction to the processing server 102. In some embodiments, the processing server 102 may be a part of the payment network 116 and receive the transaction message through internal communication methods of the payment network 116. In other embodiments, the payment network 116 may electronically transmit the transaction message to the processing server 102 using a suitable communication network and method, such as via the payment rails associated with the payment network 116 or an alternative network, such as the Internet.

The transaction message may be a specially formatted data message that is formatted according to one or more standards governing the interchange of financial transaction messages, such as the International Organization of Standardization's ISO 8583 or ISO 20022 standards. The transaction message may include a message type indicator indicating a type of the transaction message, such as an authorization request or authorization response, and one or more data elements configured to store data as indicated in the applicable standard(s). For instance, the processing server 102 may receive an authorization response for the processed payment transaction that includes data elements that store a primary account number associated with the transaction account used by the consumer 104 (e.g., identified from the payment card 110) to fund the payment transactions and the product identifier associated with the digital media rights purchased by the consumer 104 in the transaction.

The processing server 102 may identify the content pair that includes the product identifier that was included in the purchase made by the consumer 104. The processing server 102 may identify the content identifier that is paired with the product identifier in the identified content pair, and may register ownership of rights to the corresponding digital media content in a blockchain. The processing server 102 may electronically transmit at least the content identifier and a value uniquely associated with the consumer 104 to a node in a blockchain network 118. The value uniquely associated with the consumer 104 may be the primary account number associated with the payment card 110 or other suitable value. For instance, in one embodiment, the primary account number may be used to identify a digital token associated with the consumer 104 (e.g., or the transaction account used by the consumer 104 in the payment transaction). The digital token may be a data value (e.g., a 256-bit alphanumeric value) that is unique to the consumer 104 and/or transaction account that may not be traced back to the transaction account by an external entity (e.g., the media platform 106).

The blockchain network 118 may be comprised of a plurality of nodes. Each node may be a computing system that is configured to perform functions related to the processing and management of the blockchain, including the generation of blockchain data values, verification of proposed blockchain transactions, verification of digital signatures, generation of new blocks, validation of new blocks, and maintenance of a copy of the blockchain. In some embodiments, the processing server 102 may be a node in the blockchain network 118. The blockchain may be a distributed ledger that is comprised of at least a plurality of blocks. Each block may include at least a block header and one or more data values. Each block header may include at least a timestamp, a block reference value, and a data reference value. The timestamp may be a time at which the block header was generated, and may be represented using any suitable method (e.g., UNIX timestamp, DateTime, etc.). The block reference value may be a value that references an earlier block (e.g., based on timestamp) in the blockchain. In some embodiments, a block reference value in a block header may be a reference to the block header of the most recently added block prior to the respective block. In an exemplary embodiment, the block reference value may be a hash value generated via the hashing of the block header of the most recently added block. The data reference value may similarly be a reference to the one or more data values stored in the block that includes the block header. In an exemplary embodiment, the data reference value may be a hash value generated via the hashing of the one or more data values. For instance, the block reference value may be the root of a Merkle tree generated using the one or more data values.

The use of the block reference value and data reference value in each block header may result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single node in the blockchain network 118 prior to the generation and addition of a new block to the blockchain in order for the change to be made permanent. Computational and communication limitations may make such a modification exceedingly difficult, if not impossible, thus rendering the blockchain immutable.

Each blockchain data value may correspond to an entry regarding the ownership of digital media rights by a consumer 104. A blockchain data value may include at least the digital token associated with a consumer 104 (e.g., or a transaction account used by the consumer 104 to purchase the respective digital media rights) and a content identifier associated with the digital media content to which the rights were purchased. The blockchain data values stored in the blockchain may be made available to the media platform 106. For instance, the media platform may be provided with a copy of the blockchain, or the blockchain may be publicly accessible (e.g., where the use of digital tokens provides privacy to all consumers 104). In some cases, media platforms 106 may be established as nodes in the blockchain network 118.

When the consumer 104 registers with a media platform 106, they may provide their payment card 110 used to purchase digital media rights thereto. The media platform 106 may use data read from the payment card (e.g., the primary account number associated with the corresponding transaction account) to identify blockchain data values that are associated with the purchase of digital media rights by the consumer 104. In some embodiments, the media platform 106 may use the data read from the payment card to first obtain the digital token associated with the consumer 104, such as by providing the data to the processing server 102 and receiving the digital token in return. In one embodiment, the consumer 104 may provide only the digital token to the media platform 106 in place of the primary account number. In some cases, the digital token may be provided in addition to the primary account number (e.g., where the token may be provided, but where payment may still need to be made to the media platform 106 to avail the consumer 104 of the services). In some embodiments, the consumer 104 may provide their primary account number or other authentication information to the processing server 102, which may provide the digital token directly to the media platform 106 through a suitable communication network and method.

Once the media platform 106 has obtained the digital token associated with the consumer 104 (e.g., or their transaction account used to purchase digital media rights), the media platform 106 may identify all blockchain data values that include the digital token. The media platform 106 may identify the content identifiers that are included in each of the identified blockchain data values and make the associated digital media content pieces available for viewing by the consumer 104 on their computing device 108. The consumer 104 may repeat the process for other media platforms 106, which may enable the consumer 104 to view their purchased digital media content on any media platform 106 through the single purchase from the merchant system 114. The result is a system 100 where the purchase of digital media rights by the consumer 104 is platform-agnostic through use of the blockchain network 118. The digital rights owner 112 is free to allow consumers 104 to purchase or otherwise acquire rights to its digital media content in any manner, while the consumer 104 is free to consume the digital media content in any manner from any media platform 106 that has that content available.

In some embodiments, the processing server 102 may be configured to perform eligibility checks prior to the purchase of digital media rights by a consumer 104. In some instances, eligibility checks may be performed to determine eligibility of a merchant system 114 to sell digital media rights that are being sold as part of a payment transaction for which a transaction message is received by the processing server 102. In these instances, the processing server 102 may store agreement data for agreements entered into between digital rights owners 112 and merchant systems 114. When a transaction message is received, the processing server 102 may identify the product identifier included therein and look for an agreement associated therewith. The processing server 102 may then compare merchant data included in the agreement with a merchant identifier (e.g., a merchant identification number or other value unique to the merchant system 114) included in the transaction message to ensure that the merchant system 114 participating in the payment transaction is authorized to sell the digital media rights involved in the payment transaction. Such methods may be used to prevent unauthorized resale of digital media rights.

In some cases, eligibility checks may be performed to determine eligibility of a consumer 104 for the purchase of digital media rights. For instance, the digital rights owner 112 may set one or more requirements for eligibility of consumers 104 for the purchase of one or more digital media content pieces. The digital rights owner 112 may provide eligibility rules to the processing server 102 and content identifiers to which they apply. When digital media rights are to be purchased, the processing server 102 may identify the eligibility rules associated with the digital media content involved in the payment transaction (e.g., through the content identifier) and then determine eligibility of the consumer 104. The eligibility may be determined based on data associated with the consumer 104 and/or the transaction account, such as identified through the digital token. For example, the digital media rights owner 112 may require that consumers 104 must be of a certain age to purchase digital media rights for specific digital media content. The processing server 102 may identify the consumer's age as registered with a transaction account, and only submit the blockchain data entry if the consumer 104 is old enough as per the digital rights owner's eligibility requirement. In some cases, the eligibility check may be performed as part of the payment transaction, such that the transaction may be denied or the consumer 104 asked for permission to proceed with the transaction after being informed that they are not eligible for the digital media rights. Any suitable type of eligibility rules may be used in the system 100, such as age requirements, geographic location requirements, time requirements (e.g., digital media rights may only be available for purchase during a specific time window), demographic requirements, etc.

Processing Server

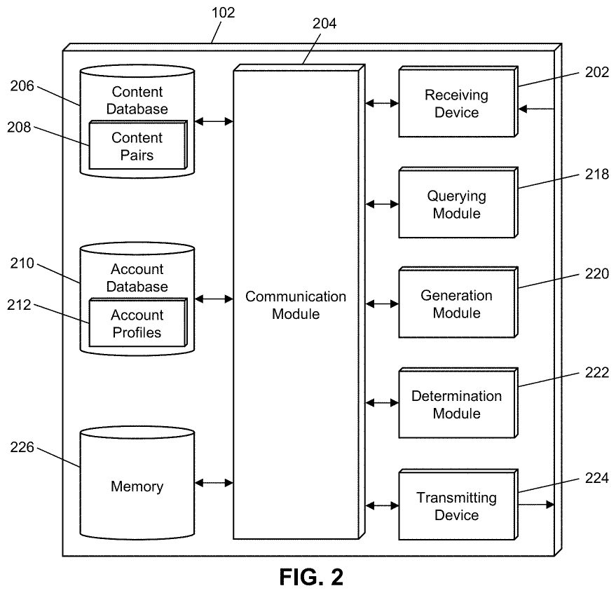

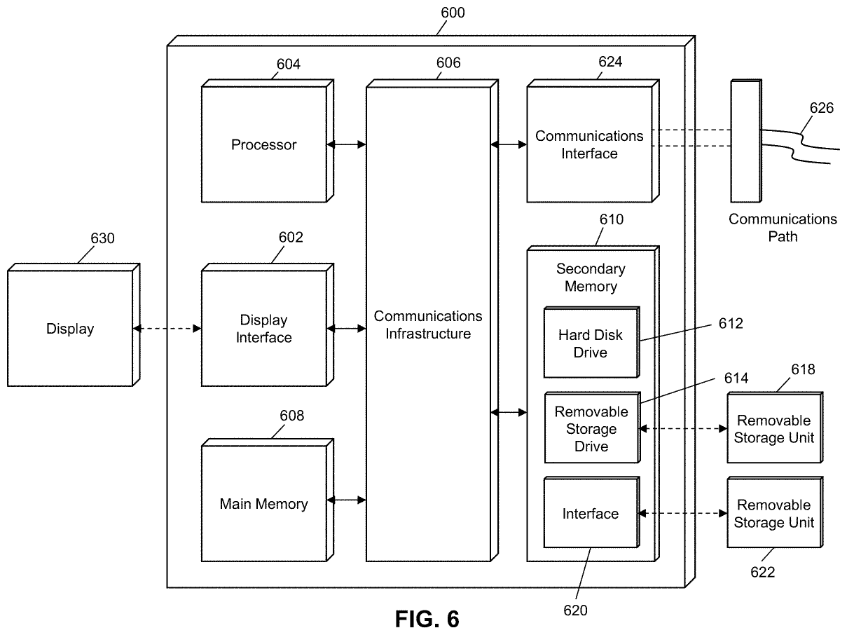

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from media platforms 106, digital rights owners 112, merchant systems 114, payment networks 116, blockchain networks 118, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by media platforms 106, which may be superimposed or otherwise encoded with requests for digital tokens, requests for blockchain data, or eligibility check requests. The receiving device 202 may be configured to receive data signals electronically transmitted by digital rights owners 112 and/or merchant systems 114 that may be superimposed or otherwise encoded with agreement data, eligibility rules, content identifiers, product identifiers, etc. The receiving device 202 may also be configured to receive data signals electronically transmitted by payment networks 116, which may be transmitted via payment rails associated therewith, and be superimposed or otherwise encoded with transaction messages for payment transactions. The receiving device 202 may also be configured to receive data signals electronically transmitted by nodes in a blockchain network 118 that may be superimposed or otherwise encoded with blockchain data, including verified blockchain data entries or new blockchain data entries or blocks for verification.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 218, generation module 220, determination module 222, etc. As used herein, the term “module” may be software operating on hardware or hardware particularly programmed to receive an input, perform one or more processes using the input, and provides an output. The input, output, and processes performed by various modules will be apparent to one skilled in the art based upon the present disclosure.

The processing server 102 may include a content database 206. The content database 206 may be configured to store a plurality of content pairs 208 using a suitable data storage format and schema. The content database 206 may be a relational database that utilizes structured query language for the storage, identification, modifying, updating, accessing, etc. of structured data sets stored therein. Each content pair 208 may be a structured data set configured to store data related to a piece of digital media content that is available for purchase. A content pair 208 may include at least a content identifier and a corresponding product identifier. In some cases, a content pair 208 may also include eligibility rules, or may be otherwise associated with eligibility rules through the included content identifier.

The processing server 102 may also include an account database 210. The account database 210 may be configured to store a plurality of account profiles 212 using a suitable data storage format and schema. The account database 210 may be a relational database that utilizes structured query language for the storage, identification, modifying, updating, accessing, etc. of structured data sets stored therein. Each account profile 212 may be a structured data set configured to store data related to a consumer 104 and/or a transaction account used to purchase digital media rights. An account profile 212 may include, for example, the digital token used to identify the related consumer 104 or transaction, the primary account number associated therewith, and any data that may be used in eligibility checks, if necessary.

The processing server 102 may include a querying module 218. The querying module 218 may be configured to execute queries on databases to identify information. The querying module 218 may receive one or more data values or query strings, and may execute a query string based thereon on an indicated database, such as the content database 206, to identify information stored therein. The querying module 218 may then output the identified information to an appropriate engine or module of the processing server 102 as necessary. The querying module 218 may, for example, execute a query on the content database 206 to identify a content pair 208 that includes a product identifier included in a received transaction message, for identification of the associated content identifier for inclusion in a new blockchain data entry.

The processing server 102 may also include a generation module 220. The generation module 220 may be configured to generate data for use by the processing server 102 in performing the functions discussed herein. The generation module 220 may receive instructions as input, may generate data based on the instructions, and may output the generated data to one or more modules of the processing server 102. For example, the generation module 220 may be configured to generate blockchain data entries for new purchases of digital media rights, which may include at least a digital token and a content identifier. In embodiments where the processing server 102 is a node in a blockchain network 118, the generation module 220 may be configured to generate new blocks, block headers, reference values, and other data as part of the functions performed by nodes in the blockchain network 118.

The processing server 102 may also include a determination module 222. The determination module 222 may be configured to perform determinations for the processing server 102 as part of the functions discussed herein. The determination module 222 may receive instructions as input, may make a determination based thereon, and output a result of the determination to another module or engine of the processing server 102. In some cases, the input may include data to be used in the determination. In some instances, the determination module 222 may be configured to identify data (e.g., via use of the querying module 218) for use in the determinations. The determination module 222 may be configured to, for example, determine eligibility of a merchant system 114 for the sale of digital media rights or eligibility of a consumer 104 or transaction account for the purchase of digital media rights.

The processing server 102 may also include a transmitting device 224. The transmitting device 224 may be configured to transmit data over one or more networks via one or more network protocols. In some instances, the transmitting device 224 may be configured to transmit data to media platforms 106, digital rights owners 112, merchant systems 114, payment networks 116, blockchain networks 118, and other entities via one or more communication methods, local area networks, wireless area networks, cellular communication, Bluetooth, radio frequency, the Internet, etc. In some embodiments, the transmitting device 224 may be comprised of multiple devices, such as different transmitting devices for transmitting data over different networks, such as a first transmitting device for transmitting data over a local area network and a second transmitting device for transmitting data via the Internet. The transmitting device 224 may electronically transmit data signals that have data superimposed that may be parsed by a receiving computing device. In some instances, the transmitting device 224 may include one or more modules for superimposing, encoding, or otherwise formatting data into data signals suitable for transmission.

The transmitting device 224 may be configured to electronically transmit data signals to media platforms 106 that are superimposed or otherwise encoded with blockchain data, digital tokens, eligibility data, etc. The transmitting device 224 may be configured to electronically transmit data signals to digital rights owners 112 and/or merchant systems 114 that are superimposed or otherwise encoded with data regarding eligibility checks, digital rights purchase data, requests for agreement data, etc. The transmitting device 224 may also be configured to electronically transmit data signals to payment networks 116, which may be superimposed or otherwise encoded with transaction messages or data associated therewith, such as in instances where the processing server 102 may perform eligibility checks are part of the processing of a payment transaction. The transmitting device 224 may also be configured to electronically transmit data signals to nodes in a blockchain network 118, which may be superimposed or otherwise encoded with new blockchain data entries, new blocks, and verification results.

The processing server 102 may also include a memory 226. The memory 226 may be configured to store data for use by the processing server 102 in performing the functions discussed herein, such as public and private keys, symmetric keys, etc. The memory 226 may be configured to store data using suitable data formatting methods and schema and may be any suitable type of memory, such as read-only memory, random access memory, etc. The memory 226 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 226 may be comprised of or may otherwise include a relational database that utilizes structured query language for the storage, identification, modifying, updating, accessing, etc. of structured data sets stored therein. The memory 226 may be configured to store, for example, blockchain data, hashing algorithms for generating blocks, credentials for validation, communication data for blockchain nodes, routing information for transaction messages, transaction message formatting standards, eligibility rules, etc.

Process for Purchase and Storage of Digital Media Rights

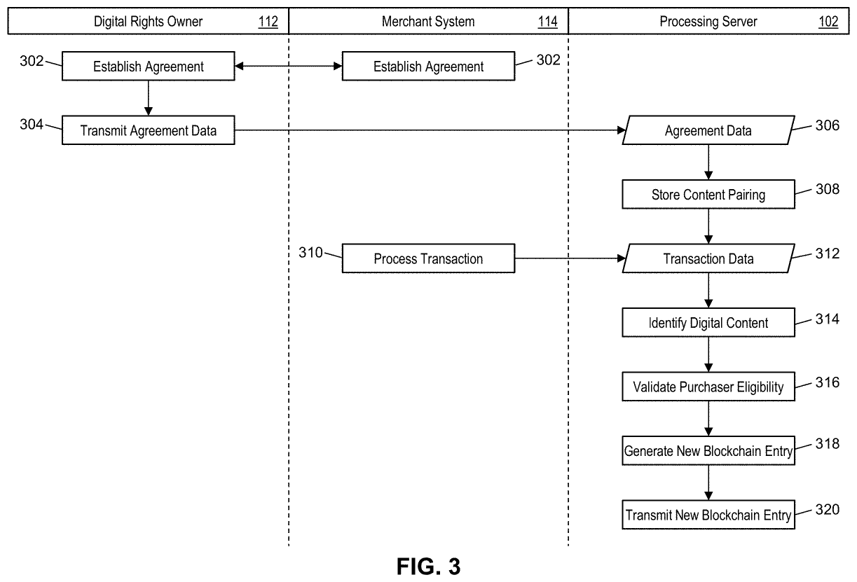

FIG. 3 illustrates an example process in the system 100 of FIG. 1 for the storage of platform-agnostic media rights using a blockchain following purchase thereof by the consumer 104 from a merchant system 114.

In step 302, the digital rights owner 112 and merchant system 114 may establish an agreement for the sale of digital media rights by the merchant system 114. Following the establishment of the agreement, in step 304, the digital rights owner 112 (e.g., or merchant system 114, as applicable) may electronically transmit the agreement data to the processing server 102. The agreement data may include at least a product identifier used in the purchase of the digital media rights and a content identifier associated with the digital media content to which the rights correspond. In some cases, the agreement data may also include eligibility rules. In step 306, the receiving device 202 of the processing server 102 may receive the agreement data.

In step 308, the querying module 218 of the processing server 102 may insert a new content pair 208 into the content database 206 of the processing server 102, where the content pair 208 includes the product identifier and associated content identifier included in the agreement data. In step 310, the merchant system 114 may initiate the processing of a payment transaction for purchase of the digital media rights by the consumer 104, which may be processed by the payment network 116. In step 312, the receiving device 202 of the processing server 102 may receive a transaction message for the payment transaction (e.g., from the payment network 116), where the transaction message includes data elements that store at least a product identifier and a primary account number.

In step 314, the querying module 218 of the processing server 102 may execute a query on the content database 206 to identify the content pair 208 that includes the product identifier stored in the transaction message, and to identify the content identifier stored therein. In step 316, the determination module 222 may determine that the consumer 104 involved in the payment transaction is eligible to purchase the digital media content associated with the content identifier based on eligibility rules (e.g., stored in the content pair 208 or identified using the content identifier, such as may be stored in the memory 226 of the processing server 102) and data associated with the consumer 104 and/or transaction account involved in the payment transaction (e.g., stored in an account profile 212 associated therewith identified via the primary account number).

In step 318, the generation module 220 of the processing server 102 may generate a new blockchain data entry for storing data indicating that the consumer 104 owns digital media rights to the purchased digital media content. The new blockchain data entry may include the content identifier and a digital token. The digital token may be the primary account number stored in the received transaction message, or a data value identified based thereon, such as found in the account profile 212 that includes the primary account number. In step 320, the transmitting device 224 of the processing server 102 may electronically transmit the new blockchain data entry to a node in the blockchain network 118 for verification and addition to the blockchain.

Process for Use of Stored Platform-Agnostic Digital Media Rights

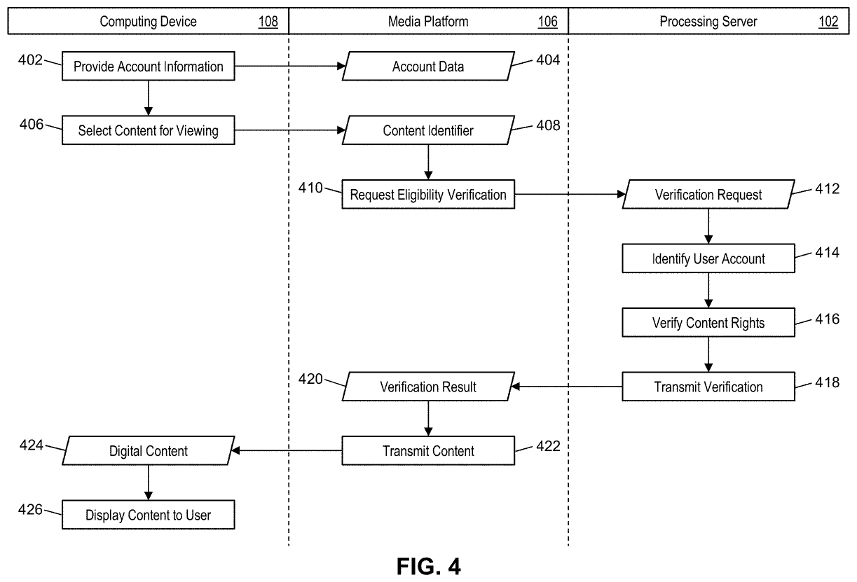

FIG. 4 illustrates an example process in the system 100 of FIG. 1 for the use of platform-agnostic media rights stored in a blockchain for viewing of associated digital media content by a consumer 104.

In step 402, the consumer 104 may use the computing device 108 to provide account information associated with the transaction account used to purchase digital media rights to the media platform 106. In step 404, the media platform 106 may receive the account information. In some cases, the account information may include a primary account number or other data directly associated with a transaction account. In such cases, the media platform 106 may be configured to (e.g., through communication with the processing server 102) identify a digital token corresponding to the primary account number for use in managing the consumer's account with the media platform. In other cases, the account information may include the digital token.

In step 406, the consumer 104 may, using the computing device 108, select a digital media content item for viewing on the media platform 106. In step 408, the media platform 106 may identify the content identifier associated with the selected digital media content item. In step 410, the media platform 106 may electronically transmit a request for eligibility verification for the digital media content item to the processing server 102. The request may include at least the content identifier and the digital token provided by the computing device 108. In step 412, the receiving device 202 of the processing server 102 may receive the request.

In step 414, the querying module 218 of the processing server 102 may execute a query on the memory 226 of the processing server 102 to identify blockchain data entries in the blockchain associated with the blockchain network 118 that include the digital token included in the received request to identify all of the digital media content rights owned by the consumer 104. In some cases, the processing server 102 may request the blockchain data entries from a node in the blockchain network 118 using the digital token. In step 416, the determination module 222 of the processing server 102 may verify that the consumer 104 has digital media rights to the selected content by identifying a blockchain data entry that includes the digital token and the content identifier included in the received request. In step 418, the transmitting device 224 of the processing server 102 may electronically transmit a response message to the media platform 106 that indicates that the consumer 104 owns digital media rights to the selected content item.

In step 420, the media platform 106 may receive the verification result from the processing server 102 using a suitable communication network and method. In step 422, the media platform may transmit the selected content item to the computing device 108 using a suitable communication network and method. In step 424, the computing device 108 may receive the digital content item. In step 426, the computing device 108 may display the digital media content item to the consumer 104 as a user thereof.

Exemplary Method for Storing Platform-Agnostic Digital Media Rights on a Blockchain

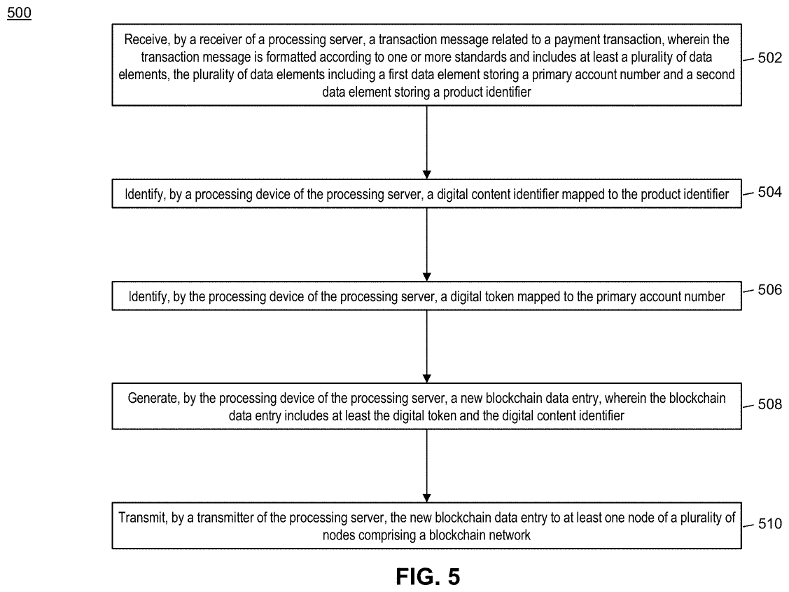

FIG. 5 illustrates a method 500 for the storage of digital media rights that are platform-agnostic on a blockchain to enable a user to view digital media rights on any suitable media platform and enable digital rights owners to retain control over distribution of digital media.

In step 502, a transaction message related to a payment transaction may be received by a receiver (e.g., the receiving device 202) of a processing server (e.g., the processing server 102), wherein the transaction message is formatted according to one or more standards and includes at least a plurality of data elements, the plurality of data elements including a first data element storing a primary account number and a second data element storing a product identifier. In step 504, a digital content identifier mapped to the product identifier may be identified by a processing device (e.g., the querying module 218) of the processing server.

In step 506, a digital token mapped to the primary account number may be identified by the processing device (e.g., the querying module 218, generation module 220, etc.) of the processing server. In step 508, a new blockchain data entry may be generated by the processing device (e.g., the generation module 220) of the processing server, wherein the blockchain data entry includes at least the digital token and the digital content identifier. In step 510, the new blockchain data entry may be transmitted by a transmitter (e.g., the transmitting device 224) of the processing server to at least one node of a plurality of nodes comprising a blockchain network (e.g., the blockchain network 118).

In one embodiment, the plurality of data elements may further include a third data element storing a merchant identifier, and the method 500 may further include determining, by the processing device of the processing server, eligibility of an entity associated with the merchant identifier to sell digital media associated with the digital content identifier based on agreement data. In some embodiments, the method 500 may also include determining, by the processing device of the processing server, eligibility of a transaction account associated with the primary account number to purchase digital media associate with the digital content identifier based on agreement data.

In some embodiments, the method 500 may further include generating, by the processing device of the processing server, a new block comprised of a header and one or more blockchain data entries, wherein the header includes at least a timestamp, a block reference value, and a data reference value and the one or more blockchain data entries includes at least the new blockchain data entry, wherein transmission of the new blockchain data entry includes transmission of the new block including the new blockchain data entry. In a further embodiment, the processing server may be one of the plurality of nodes comprising the blockchain network.

In one embodiment, the method 500 may also include receiving, by the receiver of the processing server, a verification request from a third party system (e.g., the media platform 106), wherein the verification request includes at least the digital token. In a further embodiment, the method 500 may even further include: identifying, by the processing device of the processing server, a plurality of blockchain entries stored in a blockchain associated with the blockchain network, wherein each of the plurality of blockchain entries includes the digital token and one of a set of content identifiers; and transmitting, by the transmitter of the processing server, the set of content identifiers to the third party system. In another further embodiment, the verification request may further include the digital content identifier, and the method 500 may also include: transmitting, by the transmitter of the processing server, a return message to the third party system, wherein the return message includes a confirmation of eligibility of the digital token for the digital content identifier.

Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device specifically configured to perform the functions discussed herein. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for storing platform-agnostic digital media rights on a blockchain. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

1. A method for storing platform-agnostic digital media rights on a blockchain, comprising:
receiving, by a receiver of a processing server, a transaction message related to a payment transaction, wherein the transaction message is formatted according to one or more standards and includes at least a plurality of data elements, the plurality of data elements including a first data element storing a primary account number and a second data element storing a product identifier;
identifying, by a processing device of the processing server, a digital content identifier mapped to the product identifier, the digital content identifier being associated with a plurality of digital media content pieces, which are each viewable on a different media platform;
identifying, by the processing device of the processing server, a digital token mapped to the primary account number, the digital token including at least eligibility rules for viewing one or more of the plurality of digital media content pieces;
generating, by the processing device of the processing server, a new blockchain data entry, wherein the new blockchain data entry includes at least the digital token and the digital content identifier, and wherein the new block chain includes a data reference value comprised of a hash value of at least the digital token and digital content identifier; and
transmitting, by a transmitter of the processing server, the new blockchain data entry to at least one node of a plurality of nodes comprising a blockchain network.

2. The method of claim 1, wherein
the plurality of data elements further includes a third data element storing a merchant identifier, and
the method further comprises:
determining, by the processing device of the processing server, eligibility of an entity associated with the merchant identifier to sell digital media associated with the digital content identifier based on agreement data.

3. The method of claim 1, further comprising:
determining, by the processing device of the processing server, eligibility of a transaction account associated with the primary account number to purchase the digital media associated with the digital content identifier based on the agreement data.

4. The method of claim 1, further comprising:
generating, by the processing device of the processing server, a new block comprised of a header and one or more blockchain data entries, wherein the header includes at least a timestamp, a block reference value, and the data reference value and the one or more blockchain data entries includes at least the new blockchain data entry, wherein
transmission of the new blockchain data entry includes transmission of the new block including the new blockchain data entry.

5. The method of claim 4, wherein the processing server is one of the plurality of nodes comprising the blockchain network.

6. The method of claim 1, further comprising:
receiving, by the receiver of the processing server, a verification request from a third party system, wherein the verification request includes at least the digital token.

7. The method of claim 6, further comprising:
identifying, by the processing device of the processing server, a plurality of blockchain entries stored in the blockchain associated with the blockchain network, wherein each of the plurality of blockchain entries includes the digital token and one of a set of digital content identifiers; and
transmitting, by the transmitter of the processing server, the set of content identifiers to the third party system.

8. The method of claim 6, wherein
the verification request further includes the digital content identifier, and
the method further comprises:
transmitting, by the transmitter of the processing server, a return message to the third party system, wherein the return message includes a confirmation of eligibility of the digital token for the digital content identifier.

9. A system for storing platform-agnostic digital media rights on a blockchain, comprising:
a receiver of a processing server configured to receive a transaction message related to a payment transaction, wherein the transaction message is formatted according to one or more standards and includes at least a plurality of data elements, the plurality of data elements including a first data element storing a primary account number and a second data element storing a product identifier;
a processing device of the processing server configured to
identify a digital content identifier mapped to the product identifier, the digital content identifier being associated with a plurality of digital media content pieces, which are each viewable on a different media platform,
identify a digital token mapped to the primary account number, the digital token including at least eligibility rules for viewing one or more of the plurality of digital media content pieces, and
generate a new blockchain data entry, wherein the new blockchain data entry includes at least the digital token and the digital content identifier, and wherein the new block chain includes a data reference value comprised of a hash value of at least the digital token and digital content identifier; and
a transmitter of the processing server configured to electronically transmit the new blockchain data entry to at least one node of a plurality of nodes comprising a blockchain network.

10. The system of claim 9, wherein
the plurality of data elements further includes a third data element storing a merchant identifier, and
the processing device of the processing server is further configured to determine eligibility of an entity associated with the merchant identifier to sell digital media associated with the digital content identifier based on agreement data.

11. The system of claim 9, wherein the processing device of the processing server is further configured to determine eligibility of a transaction account associated with the primary account number to purchase the digital media associated with the digital content identifier based on the agreement data.

12. The system of claim 9, wherein
the processing device of the processing server is further configured to generate a new block comprised of a header and one or more blockchain data entries, wherein the header includes at least a timestamp, a block reference value, and the data reference value and the one or more blockchain data entries includes at least the new blockchain data entry, and
transmission of the new blockchain data entry includes transmission of the new block including the new blockchain data entry.

13. The system of claim 12, wherein the processing server is one of the plurality of nodes comprising the blockchain network.

14. The system of claim 9, wherein the receiver of the processing server is further configured to receive a verification request from a third party system, wherein the verification request includes at least the digital token.

15. The system of claim 14, wherein
the processing device of the processing server is further configured to identify a plurality of blockchain entries stored in the blockchain associated with the blockchain network, wherein each of the plurality of blockchain entries includes the digital token and one of a set of digital content identifiers, and
the transmitter of the processing server is further configured to transmit the set of content identifiers to the third party system.

16. The system of claim 14, wherein
the verification request further includes the digital content identifier, and the transmitter of the processing server is further configured to transmit a return message to the third party system, wherein the return message includes a confirmation of eligibility of the digital token for the digital content identifier.
